(19) United States
(12) Patent Application Publication
(10) Pub. No.: US 2025/0124766 A1
(43) Pub. Date: Apr. 17, 2025

(54) METHOD AND SYSTEM FOR THREE BETS BLACKJACK

(71) Applicant: Matthew Tang, Egg Harbor Township, NJ (US)

(72) Inventor: Matthew Tang, Egg Harbor Township, NJ (US)

(21) Appl. No.: 18/669,521

(22) Filed: May 20, 2024

Related U.S. Application Data
(60) Provisional application No. 63/629,317, filed on Oct. 12, 2023.

(51) Int. Cl. G07F 17/32; A63F 1/00

(52) U.S. Cl. CPC G07F 17/3293; A63F 1/00; G07F 17/322; G07F 17/323; A63F 2001/003

(57) ABSTRACT

The present invention introduces a method and system for incorporating multiple cumulative total card value optional bets into the game of blackjack 21, specifically targeting the wagering player's ultimate card hand total cards value. Players have the option to place side bets on the ultimate cumulative total card thresholds reaching 19, 20 and 21. The system provides players with varying levels of risk and potential reward based on their chosen cumulative total thresholds.

### CROSS-REFERENCE TO RELATED APPLICATION

This application claims the benefit of priority of U.S. Provisional Application No. 63/629,317, filed on Oct. 12, 2023 (entitled “3 Bets Blackjack”), which is incorporated herein by reference in its entirety.

### BACKGROUND OF THE INVENTION

Blackjack 21 is a popular card game that offers excitement and strategic gameplay. To enhance player engagement, many casinos offer side bets, providing additional opportunities for wagering beyond the main game. The present invention presents a method and system for integrating multiple cumulative total cards value optional bets into the game of blackjack 21, focusing on predicting the cumulative total cards value of the player's card hand. By introducing three different predetermined cumulative total thresholds, players are provided with diverse wagering options, enriching their gaming experience.

### SUMMARY OF THE INVENTION

The present invention introduces a method and system for incorporating multiple cumulative total card value optional bets into the game of blackjack 21, specifically targeting the wagering player's ultimate card hand total cards value. Players have the option to place side bets on the ultimate cumulative total card thresholds reaching 19, 20 and 21. The system provides players with varying levels of risk and potential reward based on their chosen cumulative total thresholds.

### BRIEF DESCRIPTION OF THE DRAWING(S)

FIG. 1 is a top view of an embodiment of a game table layout of the present invention, with exemplary 3 bets (bet #1, bet #2, and bet #3) and a bonus bet.

### DETAILED DESCRIPTION OF THE PREFERRED EMBODIMENTS

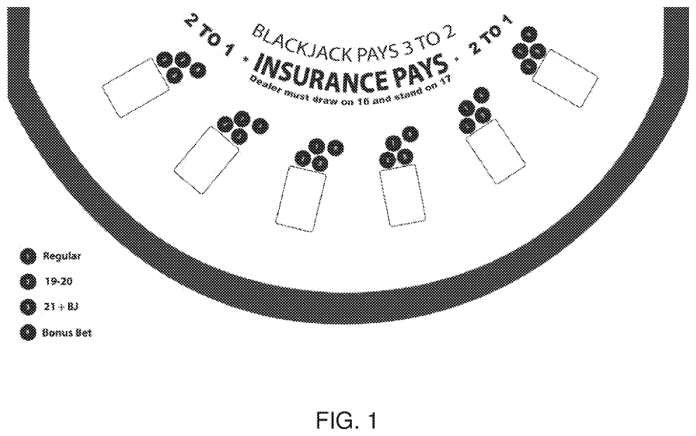

FIG. 1 shows a preferred game table layout utilized in performing the improved card game. In accordance with one aspect of the present invention, the invention provides a system for playing a game that includes a computer server having a processor configured to generate a plurality of random numbers. The server generates at least a first random number and a second random number. A user's interface is associated with the computer server. The user's interface has a processor allowing a user to request the computer server to generate one or more user requested random numbers between 1 and 11. Additional random numbers are generated one at a time, until a sum of the value of the first random number and each value of one or more additional random number exceeds 21.

In an alternative form, the present invention can be implemented as a card game such as a casino game used in professional casinos worldwide and gaming in general. In a casino embodiment, the invention can be played in conjunction with a conventional Blackjack casino-type table and a single or multiple standard deck(s) of 52 playing cards. The table surface not only has the main bet area including bet #1, bet #2, and bet #3, but also an extra bet area for an optional bonus wager. In such an embodiment, the table also displays a payoff scale on the bonus wager. As used herein, the term “card” is used in the present application to indicate a playing card of any facsimile thereof. For example, a card can be a paper playing card or an image of a card on a video display. Any representation of a card is contemplated.

The term “card game” is intended to include conventional table/board type games wherein dealer deals playing cards to one or more players, as well as any type of mechanical or electronic device which displays indicia of playing cards. Thus, the card game may be played as a live table card game, a video card game, or other computer format card game (e.g., over the Internet).

The goal of the present card game (also referred to as “Extreme Blackjack”) is to allow players to wager up to three (3) bets and a bonus wager during the initial course of play. Players must place all wagers up to 3 bets on bet #1, bet #2, bet #3, and/or the bonus wager before the cards are dealt.
a. bet #1-required to initiate game play, cumulative total cards value of player's hand must be greater than the dealer's hand and does not exceed the value of 21 to win,
b. bet #2-optional, however must be placed during initial bet, cumulative total cards value of player's hand must be 19 or 20 and greater than the dealer's hand to win,
c. bet #3-optional, however must be placed during the initial bet, cumulative total cards value of player's hand must be 21 and greater than the dealer's hand to win.

Additionally, after the bets are placed, the goal of the player is to obtain a card hand of two or more cards with a cumulative total card(s) value of 21. The values of the cards in a standard deck of cards are as follows: an ace has a value of “11” or “1”, cards “2” through “9” have a corresponding value of two through nine, and “10” and face cards have a corresponding value of “10”. The values of the cards in a hand are added together. Players have options to draw one or more card as long as not to go over 21. However, Dealer is required to draw or stand pursuant to applicable rules. If the cumulative total card(s) value results in a number of “22” or higher, it is a losing hand. Number one bet requires for initial bet. No. 2 and No. 3 bets are optional. In order to win Number 2 bet, you must have 19 or 20 to beat the dealer hand to win. To lose, the dealer must have 19 or 20 to beat the player's hand. In order to win the Number 3 bet, you must have 21 or blackjack to beat the dealer's hand. To lose, the dealer must have 21 or blackjack to beat the player hand. For example, if the dealer has 17 and player has 18, the player only can win on the number 1 bet, while the number 2 and 3 bets are not a win or loss (for the number 2 and 3 to win, it must be 19, 20, or 21/blackjack). If the dealer has 18 and the player has 17, the player will only lose number 1 bet. The number 2 and number 3 will remain the same. All copy hand is push. If the player draws 22 and above, all hands will lose.

The invention(s) described herein have the following advantages over traditional blackjack 21: A). Enhanced Player Engagement: By offering multiple cumulative total side bets, players have a variety of wagering options to choose from, increasing their overall engagement in the game. B). Increased Excitement and Anticipation: Player's experience heightened anticipation as they track the progress of their ultimate single card hand towards multiple cumulative total thresholds, adding excitement to each round of play. C). Revenue Generation: The introduction of multiple side bets creates additional revenue streams for casinos, attracting players who seek diverse and rewarding gaming experiences. In conclusion, the proposed method and system for conducting blackjack 21 with multiple cumulative total side bets on the wagering player's hand offer an innovative and engaging gaming experience, benefiting both players and casinos alike.

The invention described herein is for illustrative purposes and therefore, various equivalent modifications can be made without departing from the spirit and scope of the invention, as will be recognized by those skilled in the relevant art. The rules of the game are played with the standard blackjack rules. The number of times a player can split or double down is up to the casino discretion. Players have the option to buy insurance. The teachings provided herein of the invention can be applied to other systems for playing card games, not necessarily the gaming method generally described above. The illustrated methods can omit some acts, can add other acts, and can execute the acts in a different order than that illustrated to achieve the advantages of the invention. At the option of the casino, the amount of the winning wager payout can be increased or decreased. This will have an effect on the amount of the house percentage advantage. Higher payouts would decrease the house percentage, while lower payouts would increase the house percentage. Such modifications should be considered within the scope of the invention.

It is to be understood that the present invention is not limited to the embodiments described above or as shown in the attached figure(s), but encompasses any and all embodiments within the spirit of the invention.

1. A method for conducting a game of Blackjack 21 with multiple cumulative total cards value optional bets on a wagering player's ultimate card hand, said method comprising the steps of:
providing a standard deck or multiple decks of playing cards and establishing rules for a main game of blackjack 21;
offering players the option to place multiple optional bets on the cumulative total of their ultimate card hand reaching three different predetermined thresholds in addition to the regular bet and/or bonus bet before the cards are dealt;
tracking the cumulative total cards value of player hand and dealer's hand;
determining whether the cumulative total cards value of the wagering player's hand meets any of the predetermined thresholds and greater than the cumulative total cards value of the dealer's hand; and
calculating payouts for the wagering players based on predetermined payout odds corresponding to the cumulative total thresholds achieved by the wagering player's ultimate card hand and greater than the cumulative total cards value of the dealer's hand.

2. The method according to claim 1, wherein the player selects the predetermined thresholds equal to 19 or 20.

3. The method according to claim 1, wherein the player selects the predetermined thresholds equal to 21 or Blackjack.

4. A system for facilitating a game of Blackjack 21 with multiple optional bets on the wagering player's ultimate hand cumulative total cards values, comprising:
a gaming table equipped with a playing surface configured for conducting the main game of blackjack 21;
a display interface integrated into the gaming table or connected to a central gaming system, presenting information related to the multiple cumulative total cards value optional bets reaching three different predetermined thresholds before the cards are dealt, including all available betting options and current cumulative total statistics;
a processor-based controller programmed to manage the multiple cumulative total cards value optional bets, including accepting optional bet wagers, tracking the cumulative cards value total of relevant game events, determining the cumulative total cards value of player hand and dealer's hand and do not exceed the value of 21, and calculating all bets payouts when the cumulative total cards value of player's hand is greater than the cumulative total cards value of the dealer's hand and reaching any one of the three thresholds; and
a communication network enabling communication between the gaming table, the processor-based controller, and any external gaming systems or databases.

5. The system according to claim 4, wherein the player selects the predetermined thresholds equal to 19 or 20.

6. The system according to claim 4, wherein the player selects the predetermined thresholds equal to 21 or Blackjack.

7. A computer-readable storage medium containing instructions that, when executed by a processor, cause the processor to perform the method steps of claim 1 for conducting a game of Blackjack 21 with multiple cumulative total cards value optional bets on the wagering player's ultimate card hand.
